(19) United States
(12) Patent Application Publication
(10) Pub. No.: US 2007/0176137 A1
(43) Pub. Date: Aug. 2, 2007

(54) ARTIFICIAL SNOW AND METHOD FOR MAKING SAME

(76) Inventors: John QUEE, West Vancouver, BC (CA); Elizabeth QUEE, West Vancouver, BC (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 11/539,573

(22) Filed: Oct. 6, 2006

Related U.S. Application Data
(60) Provisional application No. 60/724,893, filed on Oct. 11, 2005.

(51) Int. Cl. C99Z 99/00

(52) U.S. Cl. 252/1; 524/451; 524/47

(57) ABSTRACT

A non-toxic, non-static, environmentally benign artificial snow product is made by extruding a mixture of starch, polyvinyl alcohol, soy flakes and talc to form an extruded starch product and smashing the extruded starch product into fragments. The fragments may be sorted by size. Colorant may be added to yield artificial snow flakes in various festive colors.

### CROSS-REFERENCE TO RELATED APPLICATION

This application claims the benefit under 35 U.S.C. §119 of application No. 60/724,893 filed on 11 Oct. 2005 and entitled ARTIFICIAL SNOW AND METHOD FOR MAKING SAME which is hereby incorporated herein by reference.

### TECHNICAL FIELD

This invention relates to artificial snow which may be used, for example, for seasonal decoration, to adorn sets for theater and movie productions, and the like. The invention also relates to a method for making artificial snow.

### BACKGROUND

Artificial snow is used for seasonal decoration of homes and businesses as well as for standing-in for real snow in theater productions, movie sets, and the like. Artificial snow may also be used in the production of advertisements and other commercial artwork. A good artificial snow resembles natural snow in texture. Where the artificial snow will be dropped from above or blown to simulate falling snow, it should drift in air relatively slowly in a manner that resembles the falling of natural snow. Artificial snow should ideally drift and lie on the ground in a way that closely resembles real snow.

Artificial snow is often displayed in places accessible to children and other members of the public, for example, in seasonal displays in businesses, homes and the like. The inventors have determined that there is a problem with some materials which have been used previously for artificial snow because these materials can be toxic, if ingested, and can also disturb the environment. In addition, some artificial snow products have yellowish tinges that can make them unsuitable for use in film production.

The inventors have identified that there is a need for a high-quality artificial snow which is environmentally benign and non-toxic.

### SUMMARY

Aspects of this invention provide artificial snow and methods for making artificial snow. Embodiments of the artificial snow are non-toxic, biodegradable, not charged with static electricity and/or colored in any of a range of colors.

One aspect of the invention provides a non-toxic, environmentally benign artificial snow comprising fine fragments of a material extruded from a mixture comprising starch 80% to 90% by volume; polyvinyl alcohol 10% to 15% by volume; talc 0% to 2½% by volume; and colorant 0% to 5% by volume.

Another aspect of the invention provides a method for making artificial snow. The method comprises extruding starch, polyvinyl alcohol and talc to yield an extruded product; smashing the extruded product into fragments; and sorting the fragments by size.

Further aspects of the invention and features of various embodiments of the invention are set out below.

### BRIEF DESCRIPTION OF DRAWINGS

In drawings which illustrate non-limiting embodiments of the invention:

FIG. 1 is a block diagram of a production line for artificial snow according to an embodiment of the invention;

FIGS. 2A and 2B are respectively a partially schematic elevation sectional view and a partially schematic plan sectional view of a device for making artificial snow according to an embodiment of the invention; and

FIG. 3 is a cross-section through a bag for packaging artificial snow.

### DESCRIPTION

The inventors have ascertained that a highly satisfactory artificial snow product that is non-toxic and environmentally benign can be made by combining the following ingredients (all percentages by volume):
starch 80% to 90% by volume;
polyvinyl alcohol 10% to 15% by volume;
talc 0% to 2½% by volume;
hydrogenated soy flakes 0% to 2½% by volume; and
colorant 0% to 5% by volume.

The starch may be provided in the form of vegetable starch such as wheat starch, potato starch or corn starch.

The polyvinyl alcohol is preferably finely powdered.

The colorant, which is optional in some embodiments, may be used to add a seasonal color to the artificial snow (for example, the artificial snow may be made to be pink, blue, green or the like as well as white). The colorant may also enhance the whiteness of the artificial snow in some embodiments.

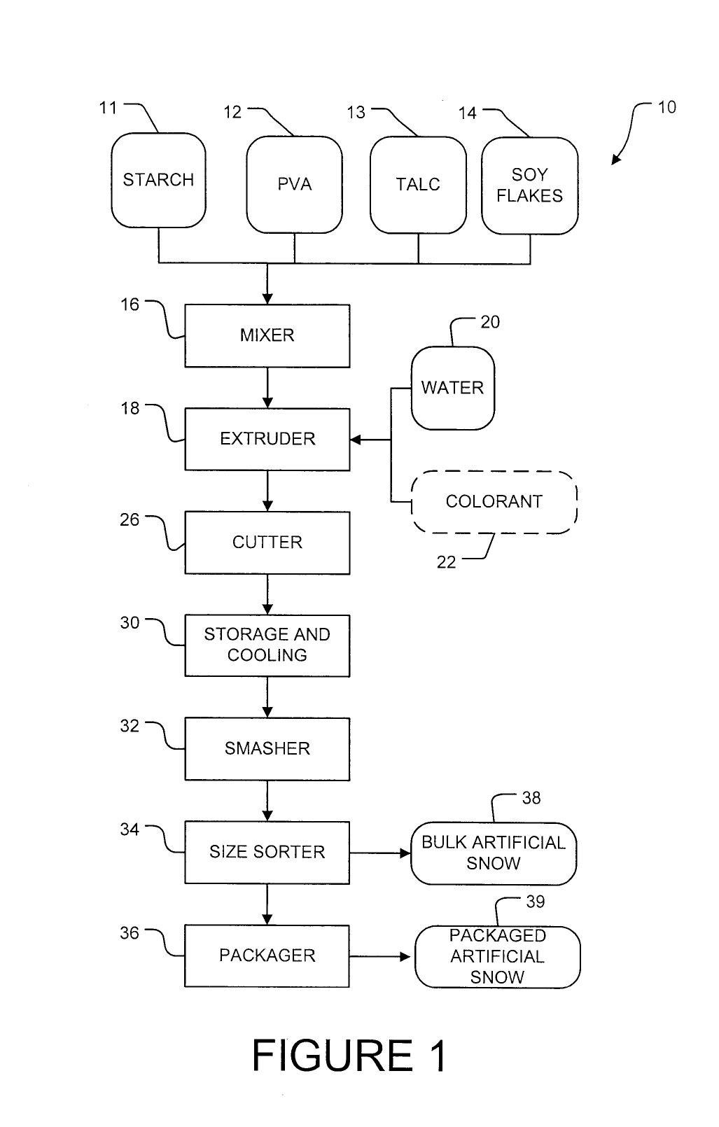

FIG. 1 shows an example production line 10 for making artificial snow according to one embodiment of the invention. Production line 10 has a source of starch 11, polyvinyl alcohol 12, talc 13 and soy flakes 14. The soy flakes are optional and are not provided in some embodiments. These materials are mixed, for example, in an electric mixer 16, and fed into an extruder 18.

Water mixture 20 is added in extruder 18 to achieve suitable extrusion of the starch mixture. In an example embodiment of the invention, the starch mixture is extruded with a water saturation of up to 13% or 15%. In some examples, the extruded starch has a water saturation in the range of 5% to 15%. In an example embodiment of the invention, the extrusion is performed through a die at a temperature in the range of 100° C. to 200° C. and a pressure in the range of 500 psi to 750 psi.

The resulting extruded starch material has a crisp outer skin and an internal cellular structure that is highly porous and irregular. The extruded starch has a density of approximately 300 to 400 grams per cubic foot (in some embodiments 340 to 380 grams per cubic foot). In some embodiments, the extruded starch has the form of a somewhat irregular cylindrical extrusion roughly ¾ inch in diameter.

It is desirable to take steps to avoid the starch product from acquiring significant electrostatic charges from the time of extrusion. Where the starch product is carried from one place to another by entraining the starch product in a flow of air flow then the air flow should preferably be maintained at a relatively low velocity to avoid static buildup.

In some instances it is desirable to make colored artificial snow. Colored artificial snow may be used to create special visual images in theater or film productions. Colored artificial snow may also be used for seasonal decorations of various kinds. For example, pink or red snow could be used as part of Valentine's Day decorations; green artificial snow may be used for St. Patrick's Day decorations; pink, blue and yellow may be used for Easter-themed decorations; and so on.

Within a method for making artificial snow according to the invention, it is possible to add a colorant 22 to cause the artificial snow to be colored. Food coloring is a suitable non-toxic colorant. A suitably colored food coloring may be mixed with the water injected in extruder 18 during the extrusion process to cause the extruded starch product to be colored. The amount of food coloring or other colorant 22 added can be selected to achieve a desired intensity of color. The amount should not be so great as to affect adversely the texture and quality of the extruded starch product.

In some embodiments, the extruded starch product, as extruded, is approximately ¾ of an inch in diameter. The material is cut into small pieces in a cutter 26. Cutter 26 may be integrated with extruder 18. The cut material is conveyed to a storage hopper 30 (this may be done by carrying the cut extruded material in a stream of air while avoiding excessive air flow velocities to reduce the buildup of static electricity). The extruded starch product is allowed to cool to ambient temperature.

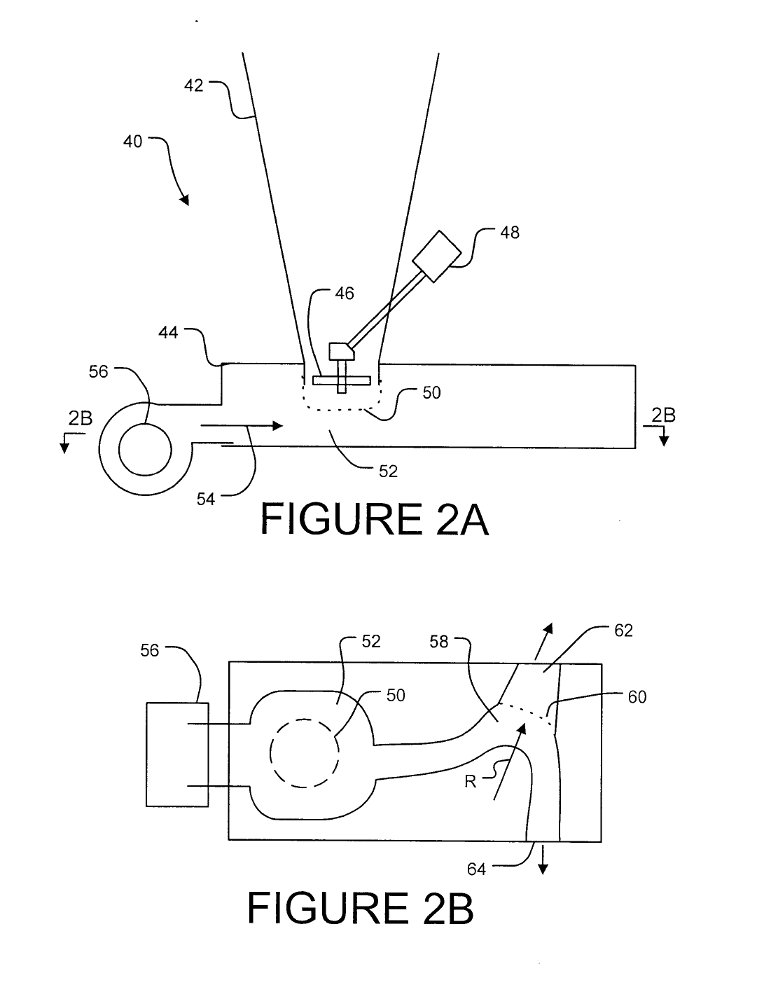

The extruded starch product is then processed to make artificial snow. This may be done by smashing the extruded products in smasher 32 and then sorting the resulting fragments by size in a size sorter 34. FIGS. 2A and 2B are views of apparatus 40 that combines the functions of a smasher 32 and a size sorter 34.

In apparatus 40, the extruded starch product is dropped into hopper 42. The extruded starch product is allowed to fall past a blunt-edged blade 46 of approximately 6 to 8 inches in diameter rotating at a speed in the range of, for example, 6,000 to 10,000 rpm. As the extruded starch pieces fall past the rotating blade 46 they are smashed into small fragments. The fragments fall through a screen 50. The size of the apertures in screen 50 may be selected depending upon how coarse or fine it is desired to make the artificial snow. Larger apertures result in coarser artificial snow flakes. Smaller apertures result in finer artificial snow flakes. The screen 50 may, for example, have apertures in the range of ⅜ of an inch to ¾ of an inch in size. Sorting the fragments by size may comprise removing fragments that are larger than or smaller than a threshold size from the fragments.

The starch fragments fall into a channel 52. The fragments are urged along the channel 52 by a flow of air 54 delivered by a blower 56. The air carries the particles along the channel 52 to an outlet 64. The channel 52 has a curved section 58 having a fine screen 60 around its outside periphery.

As very fine particles of starch pass the fine screen 60 they are expelled through the fine screen 60, where they can be collected at a separate outlet 62. The fine screen 60 may have apertures on the order of ⅛ of an inch in size, for example. The very fine particles which escape through the fine screen 60 may be used for specialty snow products as they will have a texture and appearance somewhat different from the coarser particles which pass by the fine screen 60 to the main outlet 64.

At the main outlet 64, the fragments of starch, which are now in a form suitable for use as artificial snow, are delivered to a packaging station 36 by a suitable conveyer, such as an auger, or the like. At the packaging station the artificial snow is packaged, either into boxes or other bulk storage containers to provide bulk artificial snow 38, or put into bags to provide packaged artificial snow 39 for the retail trade. Bagging may be performed by a suitable automatic bagging machine.

Because fine particles of artificial snow will tend to cling to surfaces that acquire static electrical charges, it is desirable to avoid the presence of any surfaces that can acquire a static electric charge. The conveyors and other apparatus in production line 10 are preferably made of metal, wood, or other materials that do not tend to acquire static charges. Metal components are preferably grounded. Air flows are preferably kept at relatively low velocities relative to any entrained artificial snow, extruded starch, or other artificial snow precursors to minimize the buildup of static electricity in the artificial snow or its precursors.

It has been found that a non-static artificial snow can be made by taking steps to minimize the buildup of static electricity throughout the processes described herein. Advantageously, preferred embodiments of such artificial snow can be displayed in displays in a way that appears natural and it can also fall, blow and move in air in a manner very similar to the way that natural snow falls, blows and moves in air.

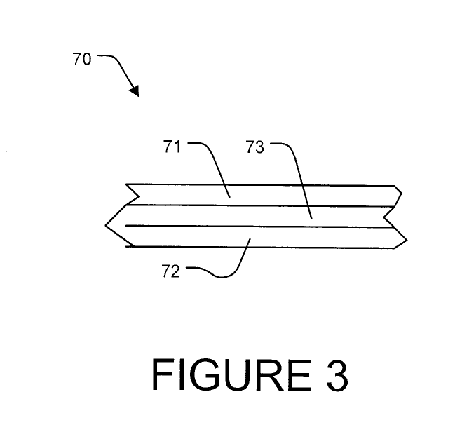

Further, it is desirable to package artificial snow in suitable non-static bags. One type of bag suitable for packaging artificial snow is shown in FIG. 3. Bag 70 is a laminated bag having an outer layer 71 of protective polypropylene, an inner layer 72 of polyethylene, and an anti-static layer 73 which is electrically conductive and dissipates any static charges which might otherwise attempt to collect on the bag.

While a number of exemplary aspects and embodiments have been discussed above, those of skill in the art will recognize certain modifications, permutations, additions and sub-combinations thereof. It is therefore intended that all such modifications, permutations, additions and sub-combinations be considered to be part of this invention. Accordingly, the scope of the invention is to be construed in accordance with the substance defined by the following claims.

What is claimed is:

1. A non-toxic, environmentally benign artificial snow comprising fine fragments of a material extruded from a mixture comprising:
starch 80% to 90% by volume;
polyvinyl alcohol 10% to 15% by volume;
talc 0% to 2½% by volume;
hydrogenated soy flakes 0% to 2½% by volume; and
colorant 0% to 5% by volume.

2. Artificial snow according to claim 1 comprising a colorant.

3. Artificial snow according to claim 2 wherein the colorant is a food coloring.

4. Artificial snow according to claim 2 wherein the artificial snow is one of pink, red, green, blue and yellow in color.

5. Artificial snow according to claim 1 having a water saturation in the range of 5% to 15%.

6. Artificial snow according to claim 1 having water saturation of up to 13%.

7. A method for making artificial snow comprising:
extruding a mixture comprising starch, polyvinyl alcohol and talc to yield an extruded product;
smashing the extruded product into fragments; and
sorting the fragments by size.

8. A method according to claim 7 wherein the mixture comprises hydrogenated soy flakes.

9. A method according to claim 7 wherein the extruded mixture has a water saturation in the range of 5% to 15%.

10. A method according to claim 7 wherein the extruded mixture has a water saturation of up to 13%.

11. A method according to claim 7 comprising packing the fragments in an anti-static package.

12. A method according to claim 11 wherein the anti-static package comprises a bag having an outer layer, an inner layer and an electrically-conductive anti-static layer between the inner and outer layers.

13. A method according to claim 7 comprising, after smashing the extruded product into fragments, sorting the fragments by size.

14. A method according to claim 7 comprising, after smashing the extruded product into fragments, urging the fragments in a flow of air to pass through a curved section of a channel wherein the channel has a fine screen on an outside periphery of the curved section.
